(19) United States
(12) Patent Application Publication
(10) Pub. No.: US 2017/0243052 A1
(43) Pub. Date: Aug. 24, 2017

(54) BOOK DETECTION APPARATUS AND BOOK DETECTION METHOD

(71) Applicant: FUJITSU LIMITED, Kawasaki-shi (JP)

(72) Inventors: Yasushi Sugama, Yokohama (JP); Masafumi Tada, setagaya (JP)

(73) Assignee: FUJITSU LIMITED, Kawasaki-shi (JP)

(21) Appl. No.: 15/431,903

(22) Filed: Feb. 14, 2017

(30) Foreign Application Priority Data
Feb. 19, 2016 (JP) 2016-030472

(51) Int. Cl. G06K 9/00; G06K 9/32; G06T 7/64; G06T 7/70; G06K 9/52

(52) U.S. Cl. CPC G06K 9/00201; G06T 7/70; G06K 9/52; G06T 7/64; G06K 9/3208; G06K 2209/501; G06F 3/0425

(57) ABSTRACT

A book detection apparatus detects a plurality of surface regions on the basis of three-dimensional measurement data that is obtained by a three-dimensional sensor and that falls within a search area, and determines, when a positional relationship between two surface regions among the plurality of surface regions satisfies a positional condition corresponding to a positional relationship between two opened pages of an opened book, the two surface regions as a book region that includes the book.

### CROSS-REFERENCE TO RELATED APPLICATION

This application is based upon and claims the benefit of priority of the prior Japanese Patent Application No. 2016-030472, filed on Feb. 19, 2016, and the entire contents of which are incorporated herein by reference.

### FIELD

The embodiments discussed herein are related to a book detection apparatus and a book detection method for detecting a book in a real space.

### BACKGROUND

In recent years, projectors for projecting images have been widely used. To make an image projected by a projector easy to view, it is preferable that the projection surface onto which the image is projected is flat. Thus, techniques for automatically detecting a projection range suitable for projecting an image from a projector have been proposed (for example, refer to Japanese Laid-open Patent Publication No. 2007-36482 and Japanese Laid-open Patent Publication No. 2006-189712.

The information projection display device disclosed in Japanese Laid-open Patent Publication No. 2007-36482 determines a projection region based on two markers placed on the projection surface and on a pre-specified basis angle, the projection region being a rectangular region having opposite angles at the two markers.

The information presenting apparatus disclosed in Japanese Laid-open Patent Publication No. 2006-189712 causes a second projector to project a checkered pattern image toward a work area. The information presenting apparatus then causes an infrared camera to take an image of the projected checkered pattern image, and matches the taken checkered pattern image against the original checkered pattern image to extract flat regions. In addition, the information presenting apparatus detects the largest and most square flat region from the extracted flat regions, and causes a first projector to project information to be presented toward the detected flat region.

### SUMMARY

Concerning the technique described in Japanese Laid-open Patent Publication No. 2007-36482, known markers need to be placed in advance in an area to be searched within a projection range. However, such markers are not always present depending on the place where a projector is used. Concerning the technique described in Japanese Laid-open Patent Publication No. 2006-189712, apart from a projector for projecting images, another projector is needed to project a special image intended to detect a flat region.

A region onto which projection is made may sometimes be a book opened at some page. In general, a book is bound along one of the edges of each page, and thus an opened page is not flat but may be deformed into a curved shape. Hence, any known markers placed on a page will be deformed in conjunction with deformation of the page, which may prevent a projection device from detecting the markers. Likewise, any special image for detecting a flat region projected onto a page deformed into a curved shape will be deformed on the page, which may prevent a projection device from detecting the special image, and consequently the projection device may fail to detect a flat region.

According to one embodiment, a book detection apparatus is provided. The book detection apparatus includes a processor configured to: detect a plurality of surface regions based on three-dimensional measurement data that is obtained by a three-dimensional sensor and that falls within a search area; and determine, when a positional relationship between two surface regions among the plurality of surface regions satisfies a positional condition corresponding to a positional relationship between two opened pages of an opened book, the two surface regions as a book region that includes the book.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a hardware configuration of a book detection apparatus according to a first embodiment;

FIG. 2 illustrates an example placement of a three-dimensional sensor and a camera;

FIG. 3 is a functional block diagram of a control unit;

FIG. 4A is a conceptual diagram illustrating detection of a flat region based on the Region Growing method;

FIG. 4B is a conceptual diagram illustrating detection of a flat region based on the Region Growing method;

FIG. 4C is a conceptual diagram illustrating detection of a flat region based on the Region Growing method;

FIG. 4D is a conceptual diagram illustrating detection of a flat region based on the Region Growing method;

FIG. 5 illustrates an example of a detected flat region and its convex contour;

FIG. 6 illustrates a relationship between a candidate region and the individual directions determined through a principal component analysis;

FIG. 7A illustrates a result of moving a model region by using a rotation matrix and a parallel translation vector that have been obtained by applying a principal component analysis on a flat region;

FIG. 7B illustrates a positional relationship between the flat region and the model region which has been moved on the basis of a result of a principal component analysis and which the ICP has been applied to.

FIG. 7C illustrates, as a reference, an example result of a direct alignment between the flat region and the model region through ICP;

FIG. 8 illustrates an example of a book opened at some page;

FIG. 9 illustrates an outline of a process performed by a book region determining unit;

FIG. 10 is an explanatory drawing illustrating an outline of a process of correcting a curved region;

FIG. 11 is a flowchart illustrating operations of a book detection process;

FIG. 12 illustrates a hardware configuration of a book detection apparatus according to a second embodiment;

FIG. 13 is a functional block diagram of a control unit according to the second embodiment;

FIG. 14 is a flowchart illustrating operations of a projection process including the book detection process performed by the book detection apparatus according to the second embodiment;

FIG. 15 illustrates a hardware configuration of a book detection apparatus according to a variation example;

FIG. 16A illustrates an example placement of an eye-gaze detection device; and

FIG. 16B illustrates an example placement of an eye-gaze detection device.

### DESCRIPTION OF EMBODIMENTS

The book detection apparatus will now be described with reference to the drawings. The book detection apparatus obtains, with a three-dimensional sensor, three-dimensional measurement data that represents a three-dimensional shape covering the whole area in which a book is searched, and, on the basis of the three-dimensional measurement data, detects a candidate surface region for a page in an opened book. Since an opened book has two neighboring opened pages, the book detection apparatus determines whether a pair of candidate regions close to each other satisfies a positional condition that corresponds to a positional relationship between two opened pages. When the pair satisfies the positional condition, the book detection apparatus identifies the pair as a book region that includes a book.

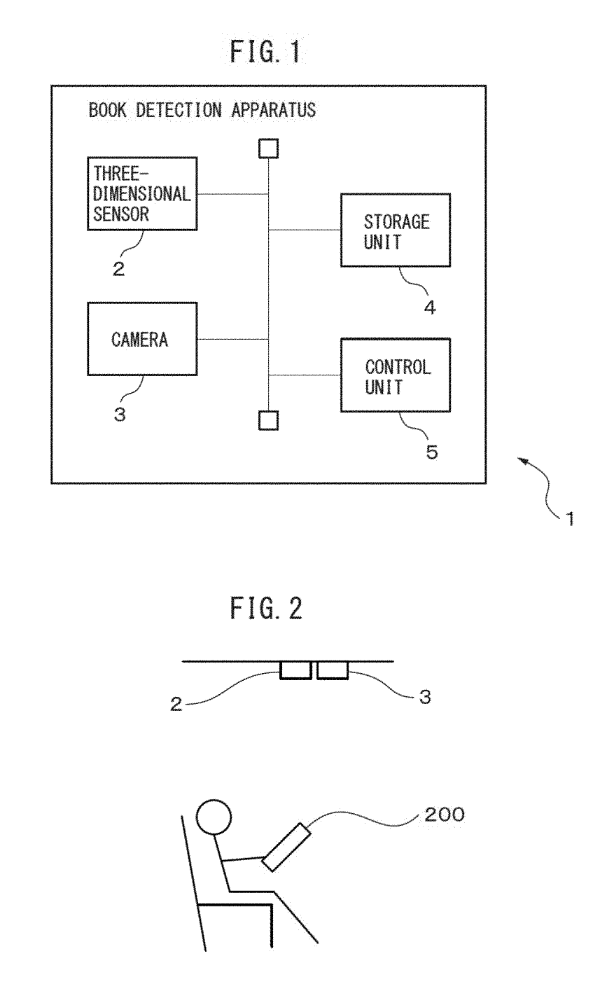

FIG. 1 illustrates a hardware configuration of a book detection apparatus according to a first embodiment. The book detection apparatus 1 includes a three-dimensional sensor 2, a camera 3, a storing unit 4, and a control unit 5. FIG. 2 illustrates an example placement of the three-dimensional sensor 2 and the camera 3. The individual units included in the book detection apparatus 1 may be contained in, for example, a single housing (not illustrated). Alternatively, the three-dimensional sensor 2 and the camera 3 may be disposed separately from the housing where the storage unit 4 and the control unit 5 are contained. The three-dimensional sensor 2, the camera 3, and the storage unit 4 each are connected to the control unit 5 via a signal line. Additionally, the book detection apparatus 1 may further include a communication interface (not illustrated) for connecting the book detection apparatus 1 to any other device over a communication network.

As illustrated in FIG. 2, the three-dimensional sensor 2 may be disposed, for example, vertically above the search area where a book 200 to be detected may be present, with the three-dimensional sensor 2 facing vertically downward. The three-dimensional sensor 2 generates three-dimensional measurement data falling within an area to be searched, at predetermined intervals (for example, every 50 to 100 msec) or at a predetermined timing. Note that an area to be searched includes at least part of a shooting range of the camera 3. Then, the three-dimensional sensor 2 outputs the generated three-dimensional measurement data to the control unit 5. For this purpose, the three-dimensional sensor 2 may be a depth camera employing, for example, the Time of Flight method, or may be a stereo camera. The three-dimensional measurement data includes real-space coordinates of individual measurement points in a search area covered by the three-dimensional sensor 2 in, for example, a three-dimensional orthogonal coordinate system having the origin at a predetermined point (for example, at the center of the sensor face on the three-dimensional sensor 2).

The camera 3, which is an example of an imaging unit, includes, for example, an image sensor and an imaging optical system that forms an image of the shooting range onto the image sensor. As with the three-dimensional sensor 2, the camera 3 may be disposed, for example, vertically above the search area where the book 200 to be detected may be present, while facing vertically downward, as illustrated in FIG. 2. The camera 3 takes an image of the shooting range at predetermined intervals (for example, every 50 to 100 msec) or in accordance with an imaging instruction signal received from the control unit 5 to generate an image that represents the shooting range. Every time an image is generated, the camera 3 passes the image to the control unit 5.

The storage unit 4 includes, for example, a volatile or non-volatile semiconductor memory circuit. The storage unit 4 stores three-dimensional measurement data obtained by the three-dimensional sensor 2, images generated by the camera 3, and the like. Furthermore, the storage unit 4 stores various information used for the book detection process, such as dimensions of the book to be detected. The storage unit 4 may further store a computer program for causing the control unit 5 to perform the book detection process.

The control unit 5 includes one or more processors and peripheral circuitry thereof. The control unit 5 controls the whole book detection apparatus 1. In addition, the control unit 5 performs the book detection process based on three-dimensional measurement data, and identifies a region representing a book on an image on the basis of positional information corresponding to the detected book. If the book represented by the identified region has a page deformed into a curved shape, the control unit 5 corrects the corresponding region on the image so that the page is virtually planar.

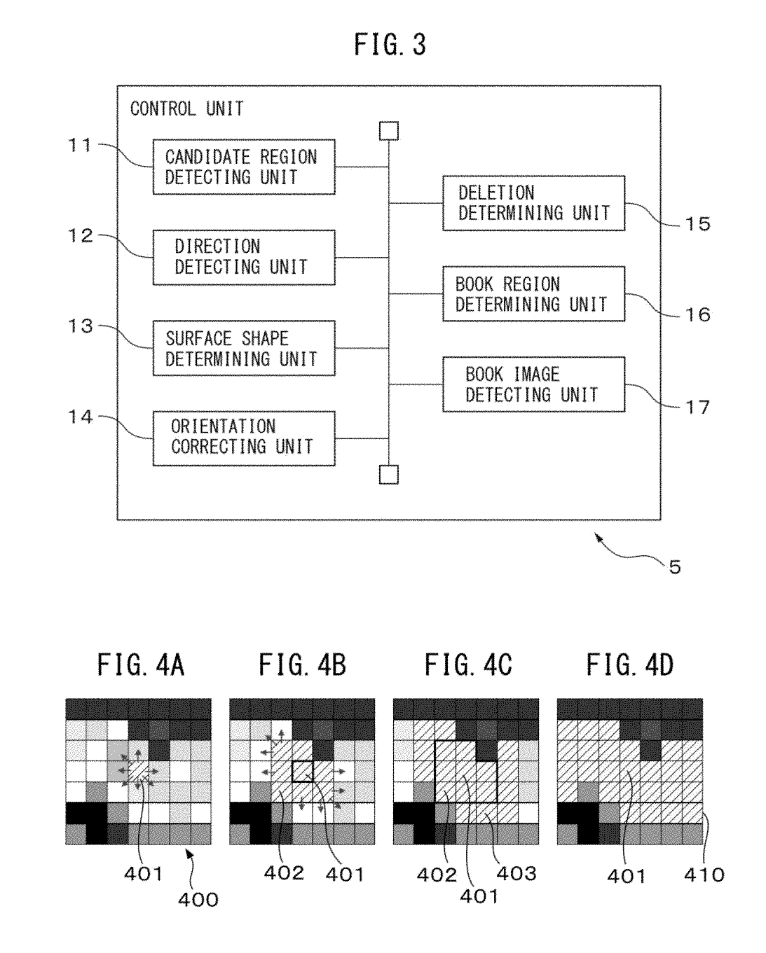

The following describes an image projecting process performed by the control unit 5. FIG. 3 is a functional block diagram of the control unit 5. The control unit 5 includes a candidate region detecting unit 11, a direction detecting unit 12, a surface shape determining unit 13, an orientation correcting unit 14, a deletion determining unit 15, a book region determining unit 16, and a book image detecting unit 17. These individual units of the control unit 5 are realized as, for example, functional modules implemented by a computer program executed on the processor included in the control unit 5. Alternatively, these individual units may be implemented in the book detection apparatus 1 separately from the control unit 5, in the form of one or more integrated circuits achieving the respective units' functions.

The candidate region detecting unit 11, which is an example of a surface region detecting unit, detects each of flat or curved surface regions within the search area on the basis of three-dimensional measurement data obtained by the three-dimensional sensor 2 as a candidate for each opened page of a book. In the present embodiment, the candidate region detecting unit 11 uses the Region Growing method to detect, as a candidate region, a set of measurement points where normal directions are different from one another by a value equal to or less than a predetermine value.

For this purpose, first, the candidate region detecting unit 11 determines the normal direction to each of the measurement points included in the three-dimensional measurement data. For example, the candidate region detecting unit 11 calculates a normal line to the measurement point of interest, by calculating, for each of sets of three points including the measurement point of interest and two points selected from a plurality of measurement points around the point of interest, a normal line to a flat surface defined by the set, and determining, using the least-squares method, the normal line which has the smallest error relative to other normal lines. Alternatively, as the normal line to the measurement point of interest, the candidate region detecting unit 11 may calculate the normal line to a flat surface defined by three measurement points around the measurement point of interest, at the centroid of which the measurement point of interest is positioned.

Once normal lines to individual measurement points are calculated, the candidate region detecting unit 11 uses the Region Growing method to determine a set of measurement points having normal directions different from one another by a value equal to or less than a predetermined value, as a candidate region.

FIGS. 4A to 4D are conceptual diagrams illustrating detection of a candidate region based on the Region Growing method. First, the candidate region detecting unit 11 selects, as a seed point 401, a single measurement point whose normal direction satisfies a predetermined condition among the measurement points included in the three-dimensional measurement data 400, and gives a unique label to the seed point 401. The predetermined condition may be, for example, that an angle between the normal direction and the optical axis direction of the camera 3 is less than a predetermined angle (30°, for example). The predetermined angle may be set to any appropriate value for a presumed range of page orientations in the state where a user is reading the book.

Next, as illustrated in FIG. 4B, the candidate region detecting unit 11 gives the same label as the one given to the seed point 401 to a measurement point 402, among measurement points adjacent to the seed point 401, whose normal direction is different from the normal direction to the seed point 401 by an angle equal to or less than a predetermined angle. In other words, the candidate region detecting unit 11 determines the measurement point 402 and the seed point 401 as a set of measurement points representing a common candidate region. However, the candidate region detecting unit 11 may exclude any measurement point that is already given another label from the region growing from the seed point 401 (i.e., the same label as the one given to the seed point 401 is not given). The predetermined angle may be, for example, 10°.

As illustrated in FIG. 4C, the candidate region detecting unit 11 repeats the processing of giving labels in a similar manner. In other words, the candidate region detecting unit 11 identifies a measurement point 403 having a normal direction different from the normal direction to the measurement point 402 by an angle equal to or less than a predetermined angle, among measurement points adjacent to the measurement point 402 which has been given the same label as the one given to the seed point 401. Then, the candidate region detecting unit 11 gives the same label as the one given to the seed point 401 to the measurement point 403. The candidate region detecting unit 11 stops the processing with respect to the seed point 401, upon finding that each measurement point adjacent to the measurement point 402 which has been given the same label as the one given to the seed point has a normal direction different from the normal direction to the measurement point 402 by an angle exceeding the predetermined angle. As illustrated in FIG. 4D, the candidate region detecting unit 11 identifies the seed point 401 and a set of measurement points that are given the same label as the one given to the seed point 401 as a single candidate region 410.

As another condition for determining that the measurement point of interest and its adjacent measurement point are included in a common candidate region, the candidate region detecting unit 11 may add a condition that a difference between the distance from the three-dimensional sensor 2 to the measurement point of interest and the distance from the three-dimensional sensor 2 to the adjacent measurement point is equal to or less than a predetermined value.

The candidate region detecting unit 11 detects a plurality of candidate regions by repeating the above-described process until there is no longer a measurement point whose normal direction satisfies a predetermined condition and which is not given any label.

The candidate region detecting unit 11 determines a convex contour of each of the detected candidate regions. For example, among the measurement points included in the candidate region of interest, the candidate region detecting unit 11 detects each measurement point having at least one of adjacent measurement points not included in the candidate region, as a contour measurement point representing part of the contour of the candidate region of interest. Then, among the contour measurement points, the candidate region detecting unit 11 identifies each contour measurement point that satisfies the condition that the inner product of two vectors connecting the contour measurement point to any two measurement points within the candidate region of interest is equal to or greater than zero. The identified contour measurement point represents a corner point of a candidate region having an angle equal to or less than 90°. Thus, the candidate region detecting unit 11 determines the contour obtained by connecting the identified contour measurement points to be the convex contour of the candidate region of interest.

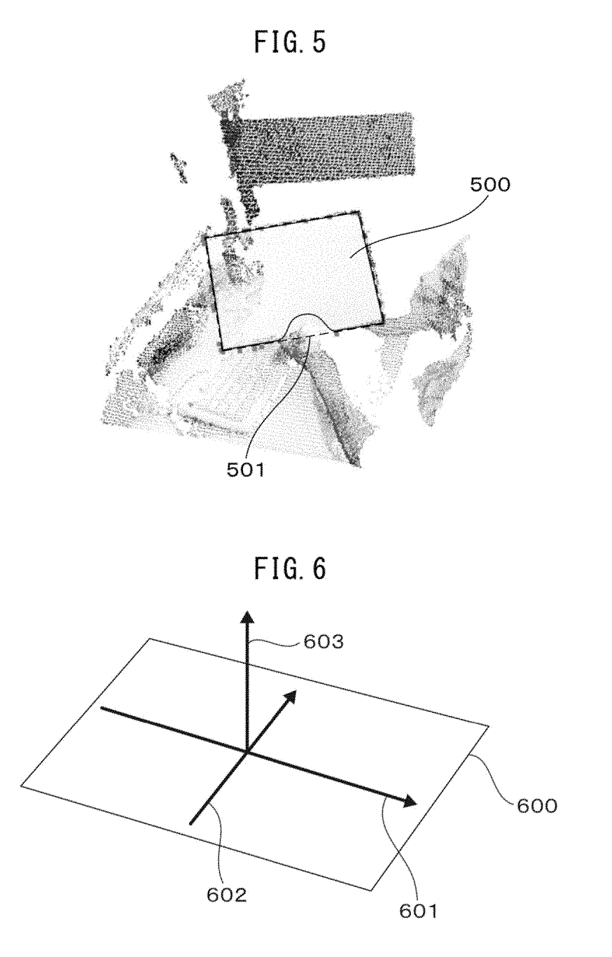

FIG. 5 illustrates an example of a detected candidate region and its convex contour. In the example, the candidate region 500 in a solid line has a cutout in its rectangular shape due to the presence of another object. Due to the cutout forming a concave, however, the convex contour 501 in a dotted line approximates to the true contour of the candidate region 500.

The candidate region detecting unit 11 stores information about each of the candidate regions, such as labels given to individual measurement points, into the storage unit 4. In addition, the candidate region detecting unit 11 stores information representing the convex contour of each candidate region (for example, coordinates of every measurement point on the contour) into the storage unit 4.

The direction detecting unit 12 detects the orientation of each of the candidate regions detected by the candidate region detecting unit 11. In the present embodiment, the direction detecting unit 12 applies a principal component analysis to each of the candidate regions to calculate a longitudinal direction, a transverse direction, and a normal direction of the candidate region. Specifically, the direction detecting unit 12 applies a principal component analysis on the candidate region of interest using, as an input, three-dimensional coordinates of each individual measurement point included in the candidate region.

FIG. 6 illustrates a relationship between a candidate region and the individual directions determined through a principal component analysis. Applying a principal component analysis with three-dimensional coordinates of each individual measurement point included in the candidate region 600 as the input provides the longitudinal direction 601 of the candidate region 600, which is a principal component. In addition, the analysis provides the transverse direction 602 of the candidate region, which is a direction containing the second highest number of components among directions orthogonal to the longitudinal direction 601, i.e., the principal component. The analysis further provides the normal direction 603 of the candidate region, which is a direction orthogonal to the longitudinal direction 601 and to the transverse direction 602.

Hence, supposing that a candidate region corresponds to a single page of a book, the longitudinal direction of the candidate region corresponds to the long edge of the page, and the transverse direction of the candidate region corresponds to the short edge of the page. The normal direction of the candidate region corresponds to the normal direction to the page. The direction detecting unit 12 stores the longitudinal direction, transverse direction, and normal direction of each candidate region into the storage unit 4.

The surface shape determining unit 13 determines whether the surface of each candidate region is flat or curved. Since the surface shape determining unit 13 may perform the same processing on every candidate region, the following describes the processing performed on a single candidate region.

For example, the surface shape determining unit 13 calculates normal directions to the individual measurement points within the candidate region of interest. To calculate the normal direction to each measurement point, the surface shape determining unit 13 may perform a processing similar to the calculation of normal directions to measurement points performed by the candidate region detecting unit 11. Then, the surface shape determining unit 13 calculates the variance value of the normal directions to the individual measurement points within the candidate region of interest.

To calculate the variance value of the normal directions to the individual measurement points, the surface shape determining unit 13 may use the normal directions calculated by the candidate region detecting unit 11 for the individual measurement points within the candidate region of interest.

The surface shape determining unit 13 compares the variance value of the normal directions to the candidate region of interest with a predetermined threshold. In general, if the surface of a candidate region is flat, normal lines to the individual measurement points are oriented in the same direction, and thus the variance value of the normal directions is small. On the other hand, if the surface of a candidate region is curved, normal lines to the individual measurement points are oriented in different directions depending on the curves on the surface, and thus the variance value of the normal directions is relatively large. Accordingly, the surface shape determining unit 13 determines that the surface of the candidate region of interest is curved when the variance value of the normal directions is equal to or greater than a predetermined threshold. On the other hand, the surface shape determining unit 13 determines that the surface of the candidate region of interest is flat when the variance value of the normal directions is less than a predetermined threshold.

Alternatively, the surface shape determining unit 13 may calculate the maximum value of positional differences between measurement points along the normal direction that has been calculated for the candidate region of interest, and determine that the surface of the candidate region is curved when the maximum value is equal to or greater than a predetermined threshold. In this case, the predetermined threshold may be, for example, a value obtained by multiplying the length in the direction parallel to the binding edge of a page of a book to be detected by 0.1.

The surface shape determining unit 13 notifies the orientation correcting unit 14 of each candidate region whose surface has been determined to be flat, while notifying the deletion determining unit 15 of each candidate region whose surface has been determined to be curved.

The orientation correcting unit 14 obtains a more accurate orientation for each of the candidate regions whose surfaces have been determined to be flat. For example, the orientation correcting unit 14 applies an Iterative Closest Point (ICP) algorithm to each of the candidate regions whose surfaces have been determined to be flat to correct the orientation of the candidate region. For this purpose, the orientation correcting unit 14 identifies, as an initial position, a rectangular model region that is aligned with the orientation of the candidate region and that is used as a model for a page, and applies the ICP algorithm between the model region and the convex contour of the candidate region. A candidate region whose surface is determined to be flat is hereinafter simply referred to as a flat region.

The orientation correcting unit 14 determines the initial position of each flat region for ICP by moving the model region to a position of the flat region through the use of a parallel translation vector and a rotation matrix that are defined from the longitudinal, transverse, and normal directions of the flat region.

The orientation correcting unit 14 moves the model region to the position of the flat region of interest in accordance with the following equation:

p′ₙ=Rpₙ+t (1)

wherein pₙ and p′ₙ represent three-dimensional coordinates of a point within the model region before and after the movement, respectively. In addition, t is a parallel translation vector representing the amount of parallel translation, such as a vector representing the amount of movement from the centroid of the model region to the centroid of the flat region of interest. R is a rotation matrix expressed by the following equation:

$$R = ( \begin{matrix}{T}_{x} & {B}_{x} & {N}_{x} \\ {T}_{y} & {B}_{y} & {N}_{y} \\ {T}_{z} & {B}_{z} & {N}_{z}\end{matrix} ) \qquad ( 2 )$$

wherein (Tₓ, T_{y}, T_{z}) represent the x-axis direction component, the y-axis direction component, and the z-axis direction component, respectively, of the unit vector representing the longitudinal orientation of the flat region of interest. Likewise, (Bₓ, B_{y}, B_{z}) represent the x-axis direction component, the y-axis direction component, and the z-axis direction component, respectively, of the unit vector representing the transverse orientation of the flat region of interest. Likewise, (Nₓ, N_{y}, N_{z}) represent the x-axis direction component, the y-axis direction component, and the z-axis direction component, respectively, of the unit vector representing the normal orientation of the flat region of interest. The x-axis direction, the y-axis direction, and the z-axis direction represent the respective axis directions in, for example, an orthogonal coordinate system with its origin at the center of the sensor face on the three-dimensional sensor 2.

After moving the model region to the position of its flat region, the orientation correcting unit 14 performs, setting the post movement position as an initial ICP position, the ICP between the model region and the convex contour of the flat region. The orientation correcting unit 14 can then calculate the amount of parallel translation and the rotation matrix for each flat region, in order that the model region is aligned with its flat region in terms of orientation and position. Alternatively, the orientation correcting unit 14 may use a tracking process other than the ICP between the model region and the convex contour of the corresponding flat region to calculate the amount of parallel translation and the rotation matrix, so that the model region is aligned with its flat region in terms of orientation and position.

The orientation correcting unit 14 aligns the model region with the flat region of interest in terms of orientation and position in accordance with the following equation:

p″ₙ=(Rpₙ+t)R′+t′ (3)

wherein p″ₙ represents three-dimensional coordinates of the point corresponding to point pₙ within the model region, after alignment with the flat region of interest. In addition, t′ and R′ represent the amount of parallel translation and the rotation matrix, respectively, as calculated through the ICP.

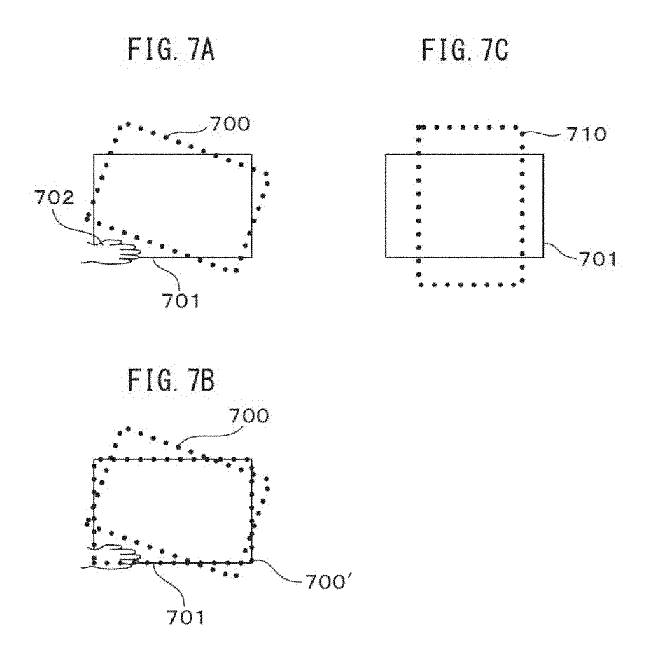

FIG. 7A illustrates a resultant model region that has been moved by using the rotation matrix and the parallel translation vector obtained through a principal component analysis applied on a flat region. With the rotation matrix and the parallel translation vector obtained through the principal component analysis applied on the flat region 701, the model region 700 in a dotted line is moved closer to the flat region 701. However, the alignment based only on the result of a principal component analysis does not provide a perfect match between the model region 700 and the flat region 701 because an error caused by, for example, an object 702 masking part of the flat region 701 remains.

FIG. 7B illustrates a positional relationship between the flat region and the model region which has been moved based on the result of a principal component analysis and which the ICP has been applied to. As illustrated in FIG. 7B, setting the post movement position of the model region 700 as the initial position, the model region 700 is further moved on the basis of the rotation matrix and the like obtained by performing the ICP between the model region 700 and the convex contour of the flat region 701. The model region 700′ that has been moved (illustrated in a dotted line) is now satisfactorily aligned with the flat region 701.

FIG. 7C illustrates, as a reference, an example result of alignment between the model region and the flat region obtained without the use of a rotation matrix or the like obtained through a principal component analysis applied on the flat region. As illustrated in FIG. 7C, when the initial position for performing the ICP, i.e., the position of the model region, is greatly away from the position of the flat region, the rotation matrix or the like obtained through the ICP may not be an optimal solution, and may be a solution equivalent to a local minimum. Consequently, when the ICP is directly applied to the model region, the position of the aligned model region 710 may not accurately match the position of the actual flat region 701, as illustrated in FIG. 7C. As seen above, the orientation correcting unit 14 can satisfactorily match each model region with its flat region in terms of position and orientation by using both a principal component analysis and the ICP.

The orientation correcting unit 14 determines, for each of the flat regions, the position, longitudinal direction, transverse direction, and normal direction of the model region that has been aligned with the flat region as the modified longitudinal direction, transverse direction, and normal direction of the flat region. Then, the orientation correcting unit 14 stores information representing the modified longitudinal direction, transverse direction, and normal direction of each of the flat regions into the storage unit 4.

Concerning the candidate regions whose surfaces are determined to be curved, the deletion determining unit 15 determines whether each of the candidate regions corresponds to a page of a book, on the basis of the direction of curvature of the curved surface of the candidate region. The candidate region whose surface is determined to be curved is hereinafter simply referred to as a curved region.

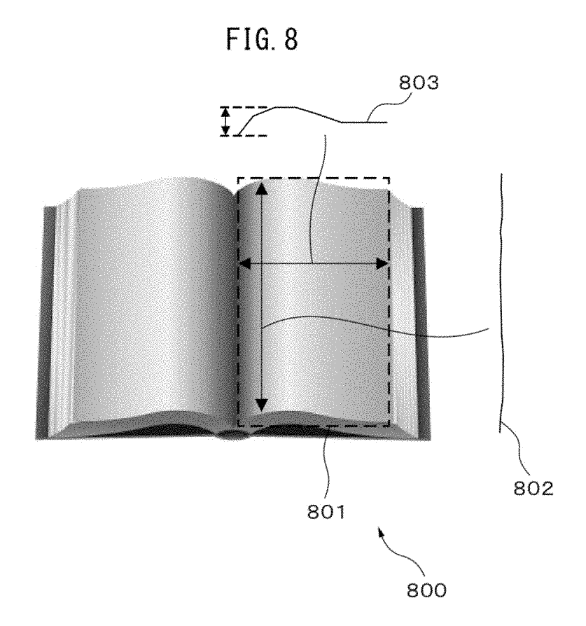

FIG. 8 illustrates an example of a book opened at some page. In general, pages are bound along one of the edges into a book, and thus a page may not be so curved along a direction parallel to the edge, but may be relatively greatly curved along a direction orthogonal to the binding edge. For example, as illustrated in FIG. 8, assuming that pages of book 800 are bound along one long edge of the pages, opened page 801 is not so curved in the long edge direction but is curved in the short edge direction.

Graph 802 represents a change of height in the normal direction of the page 801 taken along the long edge direction at a certain position in the short edge direction on the page 801. Graph 803 represents a change of height in the normal direction of the page 801 taken along the short edge direction at a certain position in the long edge direction on the page 801.

As indicated by the graph 802, the height of the page 801 does not vary so much irrespective of the positional change along the long edge direction of the page 801. On the other hand, as indicated by the graph 803, the height of the page 801 varies depending on the positional change along the short edge direction of the page 801.

Thus, the deletion determining unit 15 calculates, for each curved region, the degree of positional change along the normal direction to the curved region with respect to the direction of the curved region corresponding to the direction along which the book pages are bound, and deletes any curved region that has a degree of change greater than a predetermined variable threshold.

For example, the deletion determining unit 15 calculates, for each measurement point, the differential value of the height in the normal direction with respect to the direction corresponding to the edge along which pages of the book to be detected are bound. The following assumes that the longitudinal direction of a curved region corresponds to the edge along which pages of the book to be detected are bound. In other words, the deletion determining unit 15 calculates, for each measurement point, the differential value of the height in the normal direction with respect to the longitudinal direction. To facilitate the calculation of differential values, the deletion determining unit 15 may transform, for each curved region, the coordinate values of each measurement point within the curved region into coordinate values in an orthogonal coordinate system having the axes: the transverse direction (x-axis), the longitudinal direction (y-axis), and the normal direction (z-axis) of the curved region.

The deletion determining unit 15 calculates, for each curved region, a statistically representative differential value dD (X, Y)/dY of the height D (X, Y) along the normal direction with respect to the longitudinal direction Y of each measurement point, as the degree of positional change along the normal direction to the curved region. The statistically representative value dD (X, Y)/dY may be an average value or a median value of differential values of the height along the normal direction with respect to the longitudinal direction of each measurement point.

For each curved region, the deletion determining unit 15 compares the statistically representative differential value dD (X, Y)/dY of the height D (X, Y) with respect to the longitudinal direction of the curved region with a predetermined variable threshold Tn. When the statistically representative value dD (X, Y)/dY for the curved region of interest is equal to or less than the variable threshold Tn, the deletion determining unit 15 keeps the curved region of interest as a candidate region. On the other hand, when the statistically representative value dD (X, Y)/dY for the curved region of interest is greater than the variable threshold Tn, the deletion determining unit 15 determines that the curved region of interest is not a candidate region for a page and thus deletes the curved region.

According to a variation example, the deletion determining unit 15 calculates a difference ΔD (X) between the maximum and minimum values of the height D (X, Y) along the normal direction for each position in the X direction of the curved region. Then, the deletion determining unit 15 may use an average value or a maximum value of the differences ΔD (x) as the degree of positional change along the normal direction to a curved region with respect to a direction of the curved region corresponding to the direction along which book pages are bound.

The deletion determining unit 15 notifies the book region determining unit 16 of any curved region that is kept as a candidate region.

The book region determining unit 16 creates a pair including two candidate regions selected from a plurality of candidate regions. The book region determining unit 16 then determines whether the pair represents a book region that includes a book, on the basis of whether the positional relationship between the candidate regions included in the pair satisfies a positional condition corresponding to the positional relationship between two opened pages of an opened book.

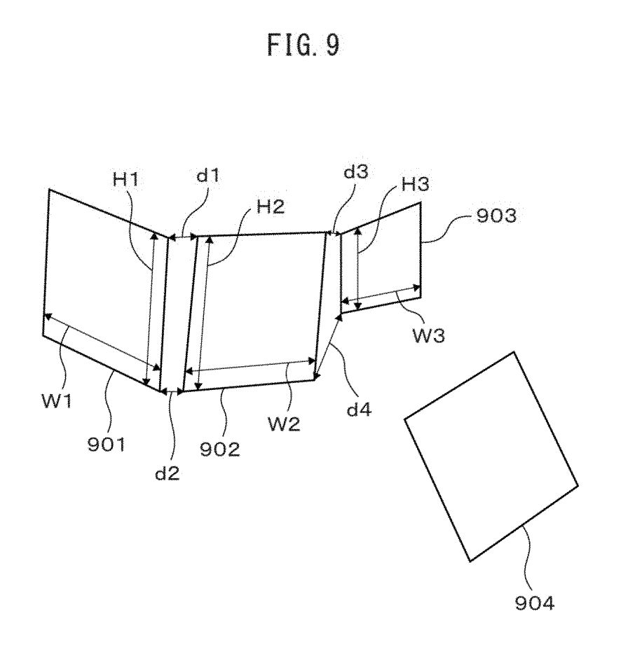

FIG. 9 illustrates an outline of a process performed by the book region determining unit 16. FIG. 9 depicts four candidate regions 901 to 904. It is assumed that the candidate regions 901 and 902 respectively correspond to a single page of a book opened at some page, while the candidate regions 903 and 904 represent something other than a book.

In general, individual pages in a book are bound along one of the edges, and thus when the book is opened at some page, two opened pages are present close to each other. In addition, the two pages are approximately equal in size. Accordingly, the distance between the candidate region 901 and the candidate region 902 is relatively small, as seen in FIG. 9. Furthermore, the size in either the longitudinal or the transverse direction of the candidate region 901 corresponding to the edge along which pages are bound is approximately equal to the size in the corresponding direction of the candidate region 902. In contrast, other candidate regions that make a pair and are irrelevant to the book, such as the candidate region 903 and the candidate region 904, are neither close to each other nor equal in size.

Hence, the book region determining unit 16 makes a pair of candidate regions by selecting two among the candidate regions. For this purpose, the book region determining unit 16 may make any possible pairs. Alternatively, if the distance between the centroids in two candidate regions is greater than a predetermined distance, the book region determining unit 16 may omit making a pair of the candidate regions. For example, with respect to the book to be detected, the predetermined distance may be set to the book size in the direction orthogonal to the edge along which pages are bound (the book size is hereinafter referred to as a book width, and the direction is hereinafter referred to as the book width direction). Next, the book region determining unit 16 calculates distances d1 and d2 between edges that are close to each other at both ends for every pair of candidate regions. When each page in the book to be detected is bound along its long edge, the book region determining unit 16 may calculate the distances d1 and d2 between edges in the longitudinal direction that are close to each other at both ends between two candidate regions included in a pair of candidate regions. When each page in the book to be detected is bound along its short edge, the book region determining unit 16 may calculate the distances d1, d2 between edges in the transverse direction that are close to each other at both ends between two candidate regions included in a pair of candidate regions.

In addition, the book region determining unit 16 calculates, for every pair of candidate regions, lengths H1 and H2 of the candidate regions included in the pair in the direction parallel to the edge along which pages of the book to be detected are bound (the direction is hereinafter referred to as the book height direction). When each page in the book to be detected is bound along its long edge, the book region determining unit 16 sets the lengths in the longitudinal direction of the candidate regions as H1 and H2, respectively. When each page in the book to be detected is bound along its short edge, the book region determining unit 16 sets the lengths in the transverse direction of the candidate regions as H1 and H2, respectively. Every candidate region may be represented by a rectangular convex contour. Thus, the book region determining unit 16 may set the length in either the longitudinal direction or the transverse direction in the convex contour as H1 or H2.

For each pair of candidate regions, the book region determining unit 16 determines whether the positional relationship between the two candidate regions included in the pair satisfies the positional condition, as expressed by the following equation, corresponding to a positional relationship between two opened pages. When the positional relationship satisfies the positional condition, the book region determining unit 16 determines that the circumscribed rectangular region for the two candidate regions included in the pair is a book region. In addition, the book region determining unit 16 determines each of the candidate regions included in the book region as a page region:

(d1+d2)/2<D

and

|H2−H1|<H (4)

wherein the threshold D may be set, for example, to a value obtained by multiplying the book width of the book to be detected by 0.05 to 0.1. The threshold H may be set, for example, to a value obtained by multiplying the size in the book height direction (hereinafter referred to as the book height) by 0.05 to 0.2.

According to a variation example, the book region determining unit 16 may compare each of d1 and d2 with the threshold D. The positional condition may thus include a condition that both d1 and d2 are less than the threshold D. Additionally, the book region determining unit 16 may sort candidate regions by distance from the centroid of the candidate region to the centroid of the nearest other candidate region in ascending order. Then, for each candidate region, the book region determining unit 16 may make a pair including the candidate region and another candidate region having the shortest distance between the centroids, and then make a pair including the candidate region and still another candidate region having the second shortest distance between the centroids. For example, according to the illustration in FIG. 9, with respect to the candidate region 902, a pair of the candidate regions 901 and 902 and a pair of the candidate regions 902 and 903 are created.

Next, with respect to the pair including the candidate regions, whose distance between the centroids is the shorter of the two pairs that include the candidate region of interest, the book region determining unit 16 calculates d1, d2, H1, and H2, as well as the lengths W1 and W2 along the book width direction. Specifically, if each page in the book to be detected is bound along its long edge, the book region determining unit 16 sets the lengths in the transverse direction of the candidate regions as W1 and W2. On the other hand, if each page in the book to be detected is bound along its short edge, the book region determining unit 16 sets the lengths in the longitudinal direction of the candidate regions as W1 and W2. Similarly, with respect to the pair whose distance between the centroids is the longer of the two pairs, the book region determining unit 16 calculates d3 and d4 representing distances between edges close to each other at both ends, H2 and H3 representing the lengths of the candidate regions in the book height direction, and W2 and W3 representing the lengths of the candidate regions in the book width direction. For example, according to the illustration in FIG. 9, with respect to the candidate region 902, d3, d4, W3, and H3 for the pair of the candidate regions 902 and 903 are calculated.

For each of the two pairs including the candidate region of interest, the book region determining unit 16 determines whether the positional relationship between the two candidate regions included in the pair satisfies the positional condition corresponding to a positional relationship between two opened pages of a book. When the one pair having the shorter distance between the centroids satisfies the positional condition and the other pair does not satisfy the positional condition, the book region determining unit 16 determines that the bounding rectangular region for the two candidate regions included in the pair having the shorter distance between the centroids is a book region. Conditions for the determination are expressed by the following equation:

$$( \begin{matrix}( d 1 + d 2 ) / 2 < D \\ and \\ \vert H 2 - H 1 \vert < H \\ and \\ \vert W 2 - W 1 \vert < W\end{matrix} ) and ( \begin{matrix}( d 3 + d 4 ) / 2 \geq D \\ or \\ \vert H 3 - H 2 \vert \geq H \\ or \\ \vert W 3 - W 2 \vert \geq W\end{matrix} ) \qquad ( 5 )$$

wherein the threshold W may be set, for example, to a value obtained by multiplying the book width by 0.05 to 0.2.

According to the variation example, the book region determining unit 16 determines whether each of the pairs satisfies the positional condition, can accurately detect a book region irrespective of any region on a surface present near the book.

The book region determining unit 16 notifies the book image detecting unit 17 of the detected book region.

The book image detecting unit 17 detects on an image taken by the camera 3 a region corresponding to the book region, as a book image. In the present embodiment, the positional relationship between the three-dimensional sensor 2 and the camera 3 is already known. A book region is represented in the real-space coordinate system based on the three-dimensional sensor 2 used as a reference. Thus, the book image detecting unit 17 transforms coordinate values of the four individual corners of a book region in the real-space coordinate system based on the three-dimensional sensor 2 into the coordinate values in the real-space coordinate system based on the camera 3. The transformation is performed through an affine transformation which corrects a positional displacement and a rotational displacement between the two coordinate systems.

Then, the book image detecting unit 17 calculates coordinates on the image corresponding to the coordinates of the four individual corners of the book region represented in the real-space coordinate system based on the camera 3. The book image detecting unit 17 determines that the region surrounded by the four corners whose coordinates have been transformed is a book image. For example, calculations of the aforementioned coordinate transformation and of corresponding coordinates are expressed by the following equations:

$$s [ \begin{matrix}x \\ y \\ 1\end{matrix} ] = ( \begin{matrix}{f}_{cx} & 0 & {c}_{cx} \\ 0 & {f}_{cy} & {c}_{cy} \\ 0 & 0 & 1\end{matrix} ) ( \begin{matrix}{R}_{dc} & {T}_{dc}\end{matrix} ) [ \begin{matrix}X \\ Y \\ Z \\ 1\end{matrix} ] \\ {R}_{dc} = ( \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ) , {T}_{dc} = ( \begin{matrix}{t}_{1} \\ {t}_{2} \\ {t}_{3}\end{matrix} ) \qquad ( 6 )$$

wherein (f_{cx}, f_{cy}) represent the focal lengths of the imaging optical system (not illustrated) included in the camera 3 in horizontal and vertical directions of an image taken by the camera 3. In addition, (c_{cx}, c_{cy}) represent the horizontal coordinate and vertical coordinate of the center of an image taken by the camera 3. The rotation matrix R_{dc} and the parallel translation vector T_{dc} are transformation parameters representing coordinate transformation from the three-dimensional coordinate system based on the three-dimensional sensor 2 to the three-dimensional coordinate system based on the camera 3. (X, Y, Z) are the three-dimensional coordinates of the point of interest (i.e., one of the four corners of the book region in this example) in the three-dimensional coordinate system based on the three-dimensional sensor 2. In addition, (x, y) are the two-dimensional coordinates of a point on an image corresponding to the point of interest.

When one of the two page regions included in the book region corresponding to the book image is a curved region, the book image detecting unit 17 corrects the book image so as to represent the page image where the curved region is virtually flattened.

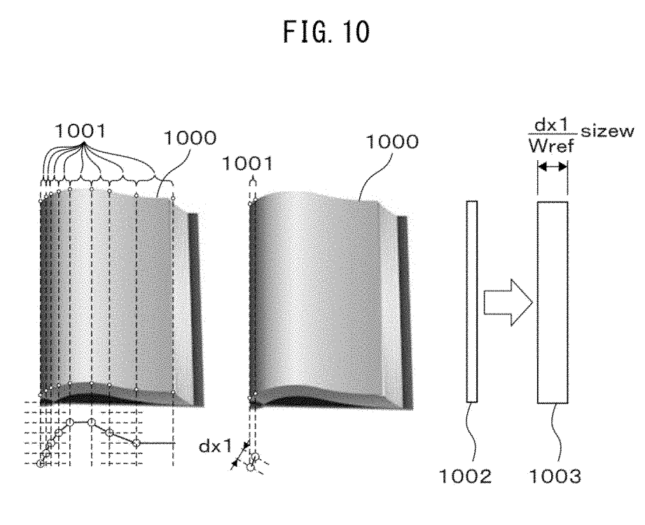

FIG. 10 is an explanatory drawing illustrating an outline of a process of correcting a curved region. The book image detecting unit 17 divides a curved region 1000 into blocks 1001 along the curved direction, i.e., along the book width direction, where the difference in height in the normal direction thereto in each block 1001 is a predetermined value. The book image detecting unit 17 applies a principal component analysis on every block 1001, as with the direction detecting unit 12. The analysis determines the direction containing the second highest number of components, as the transverse direction of a block 1001. The analysis further determines the direction containing the third highest number of components, as the normal direction to a block 1001. Then, the book image detecting unit 17 calculates the width dx1 along the transverse direction for each block 1001.

In addition, the book image detecting unit 17 calculates, for each block 1001, the four points on the image corresponding to the four corners of the block 1001 in accordance with the equation (6). In this way, the book image detecting unit 17 obtains a region 1002 (the region is hereinafter referred to as a block region for convenience) corresponding to a block 1001 on the image.

For each block 1001, the book image detecting unit 17 obtains a corrected block region 1003 by carrying out projective transformation on the corresponding block region 1002 so that the block is projected onto a plane orthogonal to the optical axis of the camera 3. For example, the book image detecting unit 17 extends block regions along the book width direction sequentially starting from the block 1001 nearest to the other page region so that the width of a corrected block region on an image is equal to (dx1/Wref)*sizew. For this purpose, the book image detecting unit 17 may determine each pixel value through linear interpolation or spline interpolation. Wref is the length of a single page along the book width direction of the book to be detected, while sizew is the number of pixels on the image corresponding to the page length Wref. The book image detecting unit 17 may perform the above-described processing by using the position of the edge of the block region of interest adjoining the immediately preceding block region as the corrected position of the adjoining edge of the immediately preceding block region. When the block region of interest is the initial block region, the book image detecting unit 17 need not change the position of the edge nearest to the other page region. The book image detecting unit 17 thus obtains a corrected book image where a curved region is virtually flattened by linking together the individual corrected block regions.

The book image detecting unit 17 stores the book image into the storage unit 4.

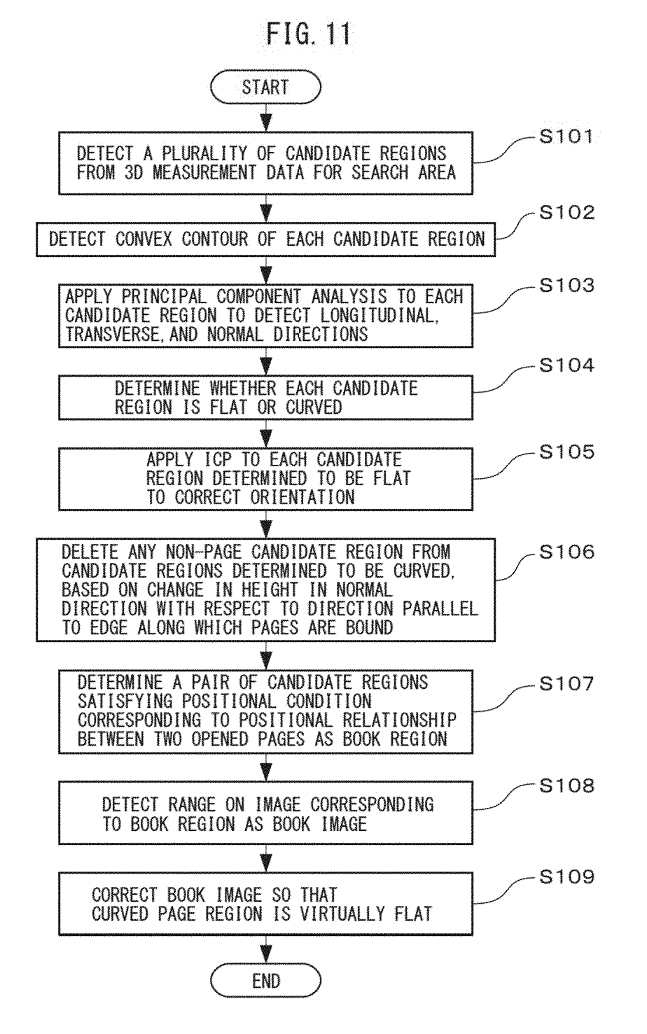

FIG. 11 is a flowchart illustrating operations of the book detection process. The control unit 5 performs the book detection process in accordance with the operation flowchart described below when, for example, any three-dimensional measurement data is acquired by the three-dimensional sensor 2.

The candidate region detecting unit 11 detects a plurality of candidate regions from the three-dimensional measurement data that is obtained by the three-dimensional sensor 2 and that falls within a search area (Step S101). The candidate region detecting unit 11 determines the convex contour of each candidate region that has been detected (Step S102).

The direction detecting unit 12 applies a principal component analysis on each of the detected candidate regions to detect the longitudinal direction, the transverse direction, and the normal direction (Step S103).

The surface shape determining unit 13 determines whether the surface of each candidate region is flat or curved (Step S104). The orientation correcting unit 14 applies the ICP to each of the candidate regions determined to be flat to correct its orientation (Step S105). On the other hand, the deletion determining unit 15 deletes any candidate region that has been found to be curved and that is determined not to be representing a page on the basis of change in the height in the normal direction with respect to the direction parallel to the edge along which pages of the book to be detected are bound (Step S106).

The book region determining unit 16 determines that a pair of candidate regions sets a book region when the two candidate regions included in the pair satisfy the positional condition corresponding to the positional relationship between two opened pages of an opened book (Step S107). The book region determining unit 16 then identifies every candidate region included in a book region as a page region.

The book image detecting unit 17 detects a range on an image taken by the camera 3 corresponding to a book region, as a book image (Step S108). In addition, when the book region corresponding to the book image contains a page region whose surface is curved, the book image detecting unit 17 corrects the region on the book image corresponding to the page region so that the curved surface is virtually flattened (Step S109). Finally, the control unit 5 completes the book detection process.

As described above, the book detection apparatus detects a plurality of flat or curved candidate regions on the basis of three-dimensional measurement data falling within a search area. Then, the book detection apparatus determines that a pair of candidate regions sets a book region when the two candidate regions included in the pair satisfy the positional condition corresponding to the positional relationship between two opened pages of a book. As a result, the book detection apparatus can detect a book even when an opened page is curved.

Depending on a book, when the book is opened at some page, each of the two opened pages may be substantially flat. The two pages of such a book may be detected together as a single candidate region. For this reason, according to a variation example, the book region determining unit 16 may determine a candidate region as a book region when the difference between the longitudinal size of the candidate region and the book width of the book to be detected is equal to or less than a predetermined width, and the difference between the transverse size of the candidate region and the book height of the book is equal to or less than a predetermined height. The predetermined width may be, for example, a value obtained by multiplying the book width of the book to be detected by 0.05 to 0.1. The predetermined height may be, for example, a value obtained by multiplying the book height of the book to be detected by 0.05 to 0.1.

According to another variation example, the direction detecting unit 12 may detect the longitudinal direction, the transverse direction, and the normal direction of each detected candidate region by using a method other than a principal component analysis. For example, the direction detecting unit 12 calculates the direction of each of the vectors connecting any two measurement points on the convex contour of interest. On the basis of the calculated directions of the individual vectors, the direction detecting unit 12 creates a histogram indicating frequencies of the calculated directions of the vectors grouped by a predetermined angular range (e.g., 10°). Referring to the histogram, the direction detecting unit 12 determines the central direction of the most frequent angular range as the longitudinal direction of the candidate region. Alternatively, the direction detecting unit 12 may identify an average value or a median value of the vector directions included in the most frequent angular range as the longitudinal direction of the candidate region. Then, the direction detecting unit 12 may determine, among the directions orthogonal to the longitudinal direction, the direction that is orthogonal to the longitudinal direction and that is included in the second most frequent angular range as the transverse direction of the candidate region. In addition, the direction detecting unit 12 may determine the direction orthogonal to the longitudinal and transverse directions as the normal direction.

According to this variation example, the direction detecting unit 12 can detect directions of a candidate region with a smaller amount of calculation compared with the method based on a principal component analysis.

A book detection apparatus according to a second embodiment will now be described. The book detection apparatus according to the second embodiment recognizes, on the basis of a detected book region, the content appearing on an opened page of the book to be detected, and then projects the information relevant to the recognition result using a projector.

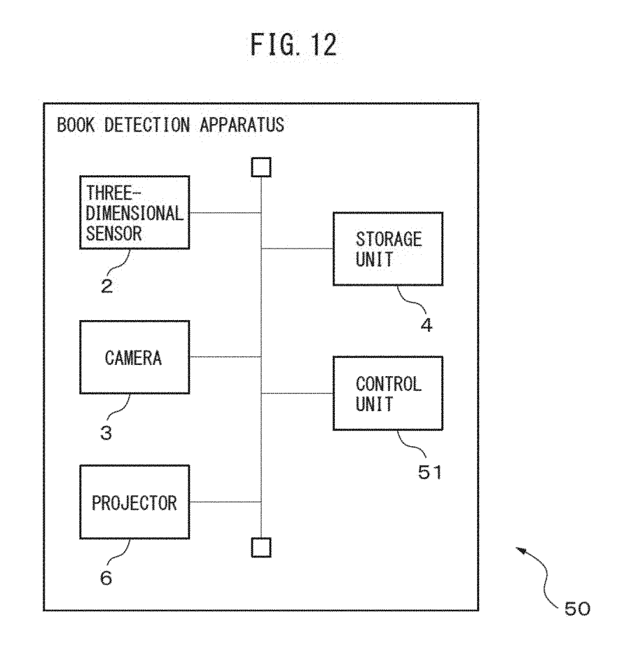

FIG. 12 illustrates a hardware configuration of the book detection apparatus according to the second embodiment. The book detection apparatus 50 includes a three-dimensional sensor 2, a camera 3, a storage unit 4, a control unit 51, and a projector 6. The individual units included in the book detection apparatus 50 may be contained in, for example, a single housing (not illustrated). Alternatively, the three-dimensional sensor 2, the camera 3, and the projector 6 may be disposed separately from the housing where the storage unit 4 and the control unit 51 are contained. The three-dimensional sensor 2, the camera 3, the projector 6, and the storage unit 4 each are connected to the control unit 51 via a signal line. Additionally, the book detection apparatus 50 may further include a communication interface (not illustrated) for connecting the book detection apparatus 50 to any other device over a communication network.

The book detection apparatus 50 of the second embodiment is different from the book detection apparatus 1 of the first embodiment in that the projector 6 is included and the processing performed by the control unit 51 is partly different. The following describes these differences.

The projector 6, which is an example of a projecting unit such as a liquid crystal projector, projects an image by displaying the image on the display surface for the projector 6 in accordance with an image signal received from the control unit 5. In the present embodiment, the projector 6 displays an image on an image display region determined by the control unit 51 so that the image is projected onto a projection range corresponding to the image display region. The projector 6 is disposed, for example, vertically above the area where a book may be present, facing vertically downward, so that the projection range can be put on a book to be detected or on a table on which the book is placed. Alternatively, the projector 6 may be disposed facing toward a certain wall so that the projection range can be put on the wall.

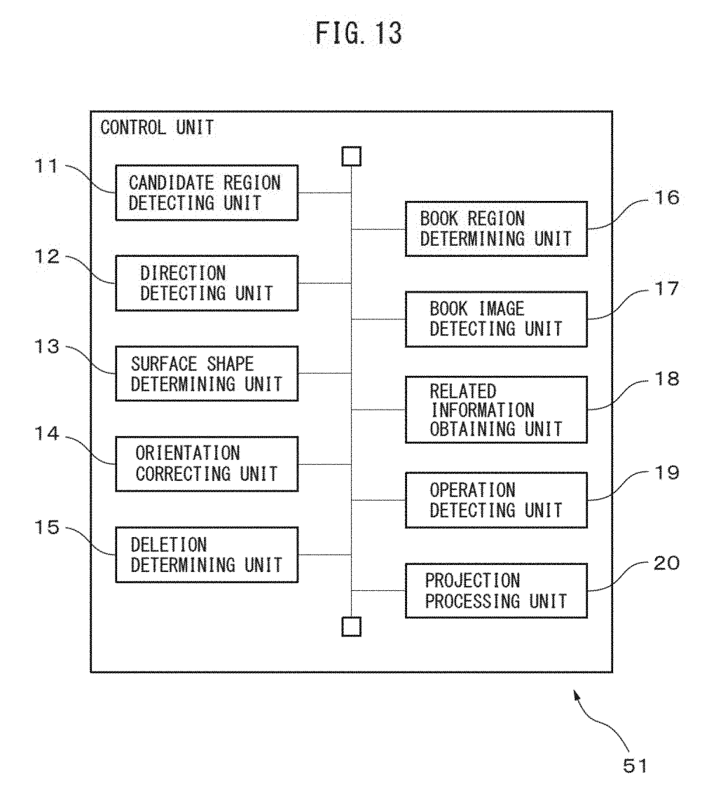

FIG. 13 is a functional block diagram of the control unit 51 according to the second embodiment. The control unit 51 includes a candidate region detecting unit 11, a direction detecting unit 12, a surface shape determining unit 13, an orientation correcting unit 14, a deletion determining unit 15, a book region determining unit 16, a book image detecting unit 17, a related information obtaining unit 18, an operation detecting unit 19, and a projection processing unit 20. These individual units of the control unit 51 are realized as, for example, functional modules implemented by a computer program executed on the processor included in the control unit 51. Alternatively, these individual units may be implemented in the book detection apparatus 50 separately from the control unit 51, in the form of one or more integrated circuits achieving the respective units' functions.

The control unit 51 of the second embodiment is different from the control unit 5 of the first embodiment in that the control unit 51 includes the related information obtaining unit 18, the operation detecting unit 19, and the projection processing unit 20. Thus, the following describes the related information obtaining unit 18, the operation detecting unit 19, and the projection processing unit 20, and the relevant part of these units.

Every time a book image is obtained, the related information obtaining unit 18 recognizes, on the basis of the book image, the content appearing on an opened page of the book to be detected as represented in the book image. The content may include, for example, an image or text. The related information obtaining unit 18 obtains information related to the recognized content from the storage unit 4 or from any other device.

For example, for each page of the book to be detected, the storage unit 4 stores in advance a template representing the content appearing on the page. The related information obtaining unit 18 performs, for each template, template matching between the book image corresponding to the detected book region and the template to calculate the matching degree, e.g., the normalized cross-correlation value. The related information obtaining unit 18 determines that, when the camera 3 generated the image, the book was opened at the page that has the content corresponding to the template of the highest matching degree.

The related information obtaining unit 18 references, for example, a related information table that indicates a correspondence relationship between content and its related information, and identifies the information related to the content appearing on the opened page. The related information table is stored in, for example, the storage unit 4 in advance. When the content is images, its related information may be, for example, some text providing detail information about the subject (e.g., a living thing, building, landscape, or person) appearing on the image, or another image, video, or three-dimensional data representing the subject. When the content is text, its related information may be, for example, an image or video of an object identified in a certain character string (e.g., a geographical or personal name) included in the text. A single element of content may be associated with a plurality of pieces of related information.

The related information obtaining unit 18 reads the identified related information from the storage unit 4. Alternatively, the related information obtaining unit 18 may obtain the identified related information from another device via a communication network. The related information obtaining unit 18 then passes the identified related information to the projection processing unit 20.

The operation detecting unit 19 detects a user operation based on time-dependent change in the position or orientation of the detected book region. For example, every time a book region is detected, the operation detecting unit 19 calculates the centroid, normal direction, and longitudinal direction of the book region. The normal direction may be determined by calculating an average value of normal directions to the two page regions included in the book region. The longitudinal direction may be the longitudinal direction in either one of the page regions. The operation detecting unit 19 then identifies time-dependent change in the moving direction and orientation of the book region by tracing the centroid or orientation of the book region. The operation detecting unit 19 references an operation table indicating a correspondence relationship between ranges of moving direction or time-dependent change in the orientation of the book region and types of operations, and identifies the operation corresponding to the moving direction or change in the orientation of the book region. The operation table is stored in, for example, the storage unit 4 in advance.

For example, shifting of a book region to the left viewed from the three-dimensional sensor 2 corresponds to the operation of projecting the related information following the related information currently projected, while shifting of a book region to the right viewed from the three-dimensional sensor 2 corresponds to the operation of projecting the related information preceding the related information currently projected.

Additionally, the change in the orientation of a book region from upward to downward in the normal direction may correspond to the operation of stopping projection of the related information. On the other hand, the change in the orientation of a book region from downward to upward in the normal direction may correspond to the operation of resuming projection of the related information.

Furthermore, positional change of a book region relative to the normal direction by clockwise rotation around the centroid of the book region may correspond to the operation of rotating clockwise the orientation of projection of the related information, which is represented by three-dimensional data. On the other hand, positional change of a book region relative to the normal direction by counterclockwise rotation around the centroid of the book region may correspond to the operation of rotating counterclockwise the orientation of projection of the related information, which is represented by three-dimensional data. In this case, the operation detecting unit 19 may change the speed of changing the orientation of projection of the related information depending on the rotation speed of the book region.

The operation detecting unit 19 gives information representing the identified operation to the projection processing unit 20.

In accordance with the identified operation, the projection processing unit 20 generates an image for the projector 6 to project the identified related information. For example, to project an image onto a book region, the projection processing unit 20 identifies an image display region, which corresponds to the book region, on the display surface for the projector 6.

For this purpose, the projection processing unit 20 transforms three-dimensional coordinates of the individual four corners of the book region to two-dimensional coordinates on the display surface for the projector 6, in accordance with the following equations. The projection processing unit 20 determines that the region surrounded by the four corners whose coordinates have been transformed is an image display region:

$$s [ \begin{matrix}u \\ v \\ 1\end{matrix} ] = ( \begin{matrix}{f}_{px} & 0 & {c}_{px} \\ 0 & {f}_{py} & {c}_{py} \\ 0 & 0 & 1\end{matrix} ) ( \begin{matrix}{R}_{dp} & {T}_{dp}\end{matrix} ) [ \begin{matrix}X \\ Y \\ Z \\ 1\end{matrix} ] \\ {R}_{dp} = ( \begin{matrix}{a}_{11} & {a}_{12} & {a}_{13} \\ {a}_{21} & {a}_{22} & {a}_{23} \\ {a}_{31} & {a}_{32} & {a}_{33}\end{matrix} ) , {T}_{dp} = ( \begin{matrix}{b}_{1} \\ {b}_{2} \\ {b}_{3}\end{matrix} ) \qquad ( 7 )$$

wherein (fₚₓ, f_{py}) represent the focal lengths of the imaging optical system (not illustrated) included in the projector 6 in horizontal and vertical directions of the display surface for the projector 6. In addition, (cₚₓ, c_{py}) represent the horizontal coordinate and vertical coordinate of the center of the display surface for the projector 6. The rotation matrix R_{dp} and the parallel translation vector T_{dp} are transformation parameters representing coordinate transformation from the three-dimensional coordinate system based on the three-dimensional sensor 2 to the three-dimensional coordinate system based on the display surface for the projector 6. Coordinates (X, Y, Z) are the three-dimensional coordinates of the point of interest (i.e., one of the four corners of the book region in this example) in the three-dimensional coordinate system based on the three-dimensional sensor 2. In addition, (u, v) are the two-dimensional coordinates of a point on the display surface for the projector 6 corresponding to the point of interest.

The projection processing unit 20 displays the image for the identified related information in the image display region on the display surface for the projector 6. In this way, the image is projected onto a book region.

Alternatively, the projection processing unit 20 may cause the projector 6 to project an image for the identified related information onto a predetermined rectangular projection region, such as on a table on which a book is placed or on a wall. Since the projection region is predetermined, the image display region corresponding to the projection region is also predetermined. Thus, for example, coordinates of the four corners of the image display region may be stored in the storage unit 4 in advance. In this case, the projection processing unit 20 may identify the image display region by reading the coordinates of the four corners of the image display region from the storage unit 4.

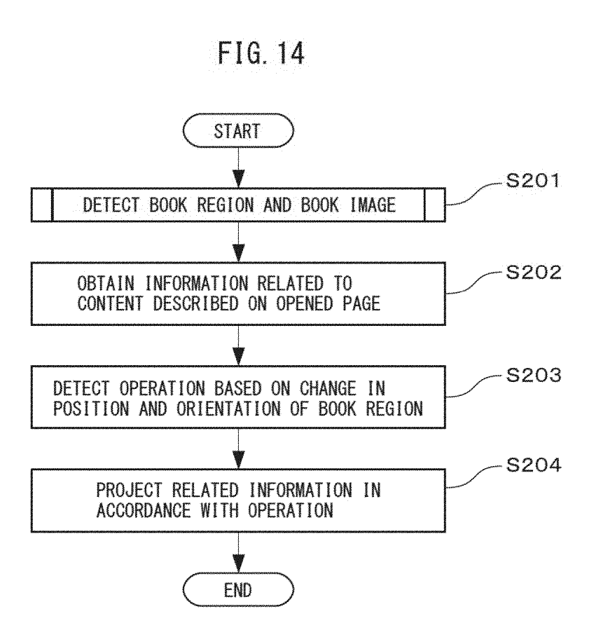

FIG. 14 is a flowchart illustrating operations of a projection process including the book detection process performed by the book detection apparatus 50 according to the second embodiment.

The control unit 51 detects a book region from three-dimensional measurement data obtained by the three-dimensional sensor 2, and detects a book image corresponding to the book region from an image taken by the camera 3 (Step S201). The control unit 51 may detect the book region and book image by, for example, following the operation flowchart illustrated in FIG. 11.

The related information obtaining unit 18 recognizes the content appearing on an opened page on the basis of the book image, and then obtains the information related to the content on the basis of the recognition result (Step S202).

The operation detecting unit 19 detects an operation by the user on the basis of time-dependent change in the position or orientation of the detected book region (Step S203).

The projection processing unit 20 causes the projector 6 to project the information related to the content in accordance with the detected operation (Step S204). Finally, the control unit 51 completes the projection process.

According to the present embodiment, the book detection apparatus can detect a book region with high accuracy, which allows the book detection apparatus to accurately recognize the content appearing on an opened page of a book in the book region and to accurately detect a user operation on the basis of movement of the book. As a result, the book detection apparatus can appropriately project the information related to the content appearing on an opened page.

According to a variation example, the operation detecting unit 19 may detect a position where the user has touched the book and identify the operation depending on the position. In this example, the operation detecting unit 19 transforms the coordinates of each measurement point in the three-dimensional measurement data from which a book region has been detected into values in an orthogonal coordinate system having the axes: the x-axis along the transverse direction, y-axis along the longitudinal direction, and z-axis along the normal direction of any one of the page regions included in the book region. Then, among the measurement points, the operation detecting unit 19 identifies a set of measurement points whose coordinates on an x-y plane are included within the x-y plane of the book region and whose values in the z direction are closer to the three-dimensional sensor 2 than the book region, as a hand of the user. When the distance in the z direction between the measurement point closest to the book region among the set of points and the book region is equal to or less than a predetermined distance threshold, the operation detecting unit 19 determines that the user is touching the book. The operation detecting unit 19 then identifies the coordinates, on an x-y plane, of the measurement point closest to the book region as the position of touch by the user.

The operation detecting unit 19 identifies the operation in accordance with the position of the touch by the user. The operation may be, for example, displaying the information related to the content appearing at the position of the touch by the user.

According to another variation example, instead of detecting the position of the touch by the user, the book detection apparatus may detect the position at which the user is gazing within a book region, and perform the operation in accordance with the detected position.

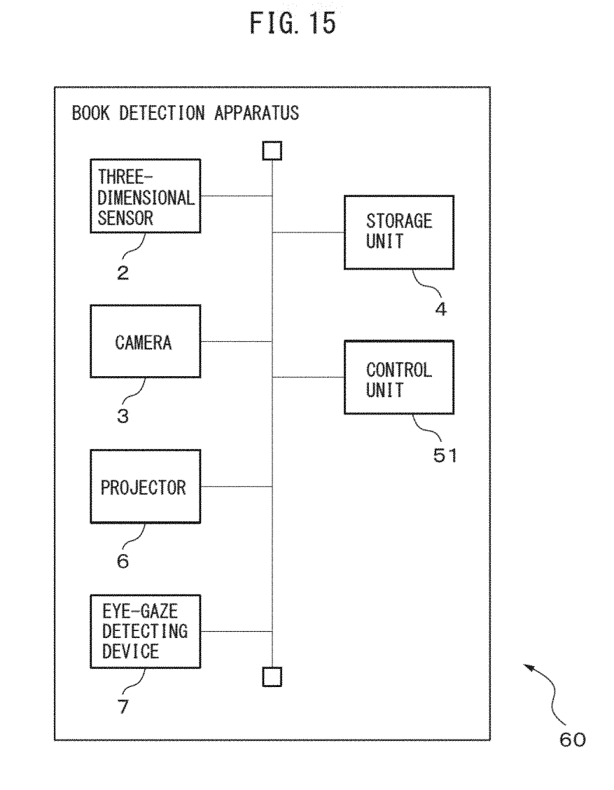

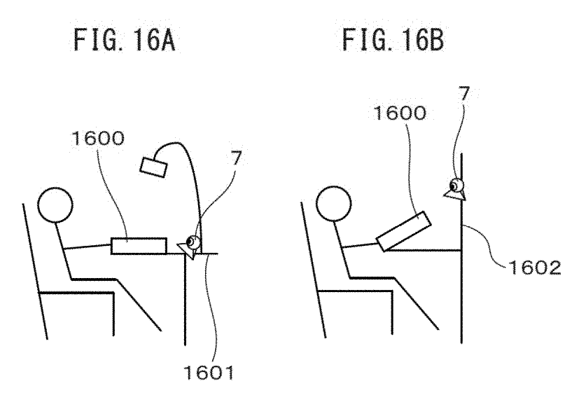

FIG. 15 illustrates a hardware configuration of a book detection apparatus according to the variation example. The book detection apparatus 60 includes a three-dimensional sensor 2, a camera 3, a storage unit 4, a control unit 51, a projector 6, and an eye-gaze detection device 7. FIGS. 16A and 16B each illustrate an example placement of the eye-gaze detection device 7.

The book detection apparatus 60 of the present variation example is different from the book detection apparatus 50 of the second embodiment in that the eye-gaze detection device 7 is included and the processing performed by the control unit 51 is partly different. The following describes these differences.

The eye-gaze detection device 7 includes, for example, a light source that emits infrared light, e.g., infrared light emitting diode, and an infrared camera that senses infrared light. As illustrated in FIG. 16A, the eye-gaze detection device 7 is disposed, for example, on a table 1601 on which a book 1600 to be detected is placed, facing toward the expected position where the user's face is present. Alternatively, as illustrated in FIG. 16B, the eye-gaze detection device 7 may be disposed on a wall 1602 standing in front of the user, facing toward the expected position where the user's face is present.

During the book detection process, the eye-gaze detection device 7 generates, at a certain frame rate, infrared images containing at least part of the user's face including his/her eye while emitting light from the light source. Thus, the user's eye illuminated by the light source is represented in an infrared image. The region having an eye of the user on an infrared image contains an image of the light source reflected from the cornea (hereinafter referred to as a Purkinje image) with an image of the pupil. As described later, the user's eye direction is detected on the basis of a positional relationship between the Purkinje image and the centroid of the pupil.

Every time an infrared image is generated, the eye-gaze detection device 7 outputs the infrared image to the control unit 51.

An operation detecting unit 19 in the control unit 51 detects the user's eye direction and a gaze point in a book region on the basis of an infrared image. The operation detecting unit 19 then identifies the user operation on the basis of the gaze point.

Every time an infrared image is provided, the operation detecting unit 19 detects the Purkinje image and the pupil on the infrared image, and then detects the user's eye direction and the gaze point on the basis of the positional relationship between the Purkinje image and the pupil.

In the present embodiment, the operation detecting unit 19 performs template matching between a template corresponding to the cornea of one of the eyes and the infrared image, and detects a region on the infrared image that has the highest matching degree with the template. The template may be stored in the storage unit 4 in advance. When the highest matching degree is greater than a predetermined matching threshold, the operation detecting unit 19 determines that the detected region is a pupil region containing an image of the pupil. A plurality of templates for different pupil sizes may be prepared. In this case, the operation detecting unit 19 performs the template matching between every template and the infrared image to determine the highest matching degree. When the highest matching degree is greater than a matching threshold, the operation detecting unit 19 determines that the region overlapping with the template of the highest matching degree is the pupil region. The matching degree may be, for example, the normalized cross-correlation value calculated for a template and an area overlapping the template. The matching threshold may be set to, for example, 0.7 or 0.8.

In a region containing the pupil, the luminance of the pupil is lower than that of its surrounding area, and the pupil is substantially circular. Thus, the operation detecting unit 19 sets two concentric rings of different radii on an infrared image. When a difference value obtained by subtracting the average luminance value of pixels corresponding to the inner ring from the average luminance value of pixels corresponding to the outer ring is greater than a predetermined threshold, the operation detecting unit 19 may determine that the region surrounded by the inner ring is the pupil region. Additionally, the operation detecting unit 19 may add the condition that the average luminance value of a region surrounded by the inner ring is equal to or less than a predetermined threshold to the conditions for detecting a pupil region. In this case, the predetermined threshold may be, for example, a value obtaining by adding 10 to 20% of the difference between the maximum luminance value and the minimum luminance value of an infrared image to the minimum luminance value.

Once a pupil region is successfully detected, the operation detecting unit 19 calculates the positional coordinates of the centroid of the pupil region, wherein the coordinates are an average value of horizontal coordinates and an average value of vertical coordinates of the pixels included in the pupil region.

The operation detecting unit 19 detects a Purkinje image in and around the pupil region. The region of a Purkinje image has higher luminance compared with its surrounding region and the luminance value of the Purkinje image is substantially saturated (i.e., the luminance value is approximately the highest of possible luminance values of pixels). In addition, the region of a Purkinje image substantially matches the light-emitting face of the light source in shape. Thus, the operation detecting unit 19 sets two rings in and around the pupil region, the two rings substantially matching the contour of the light-emitting face of the light source in shape, being different from each other in size, and being concentric. The operation detecting unit 19 then calculates a difference value by subtracting the average luminance value of pixels of the outer ring from the inner average luminance value, which is the average luminance value of pixels corresponding to the inner ring. When the difference value is greater than a predetermined difference threshold and the inner average luminance value is greater than a predetermined luminance threshold, the operation detecting unit 19 determines that the region surrounded by the inner ring is a Purkinje image. The difference threshold may be, for example, an average of difference values between luminance values of adjacent pixels in and around the pupil region. The predetermined luminance threshold may be, for example, 80% of the highest luminance value in and around the pupil region.

Note that the operation detecting unit 19 may detect a region containing the pupil by using any of various other methods for detecting a pupil region represented on an image. Likewise, the operation detecting unit 19 may detect a region containing a Purkinje image of the light source by using any of various other methods for detecting a region of a Purkinje image of the light source on an image.

Once a Purkinje image is successfully detected, the operation detecting unit 19 calculates the positional coordinates of the centroid of the Purkinje image, wherein the positional coordinates are an average value of horizontal coordinates and an average value of vertical coordinates of the pixels included in the Purkinje image. After the centroid of the Purkinje image and the centroid of the pupil are detected, the operation detecting unit 19 detects an eye direction and a gaze point.

Since the surface of cornea is substantially spherical, the Purkinje image remains almost at a fixed position irrespective of the eye direction. On the other hand, the centroid of the pupil moves as the eye direction changes. Accordingly, the operation detecting unit 19 can detect the eye direction by determining the relative position of the centroid of the pupil in relation to the centroid of the Purkinje image used as a reference.

In the present embodiment, the operation detecting unit 19 calculates the relative position of the centroid of the pupil in relation to the centroid of the Purkinje image by, for example, subtracting the horizontal coordinate and vertical coordinate of the centroid of the Purkinje image from the horizontal coordinate and vertical coordinate of the centroid of the pupil. Then, the operation detecting unit 19 references a look-up table indicating a relationship between relative positions of the centroid of the pupil and eye directions to determine the eye direction.

In addition, the operation detecting unit 19 detects the user's gaze point on the basis of the detected eye direction.

In the present embodiment, the operation detecting unit 19 determines the gaze point by referencing a gaze point table indicating a relationship between eye directions and points of gaze. The relationship between the eye direction and the gaze point changes with the distance between the gaze point (any point within a book region in the present embodiment) and the user.

For this reason, the gaze point table indicates a relationship between eye directions and points of gaze in accordance with an expected distance (e.g., 30 to 50 cm) between the user and the book to be detected. The gaze point is represented by a relative position in relation to an eye direction (e.g., the eye direction identified when the centroids match between the pupil and the Purkinje image) used as a reference. The gaze point table may be prepared in advance and stored in the storage unit 4.

Furthermore, the operation detecting unit 19 detects the position of the user's eye in a real space. Since each pixel on an infrared image corresponds to an angle to the optical axis of the infrared camera for the eye-gaze detection device 7 on a one-to-one basis, the operation detecting unit 19 can identify the direction from the eye-gaze detection device 7 to the user's eye based on the position of a Purkinje image on the infrared image. Assuming that the three-dimensional sensor 2 is disposed above the search area facing vertically downward, as described above, distances from the three-dimensional sensor 2 to the measurement points corresponding to the user's head are presumed to be relatively small. Hence, the operation detecting unit 19 examines the change in distance, along the line from the eye-gaze detection device 7 toward the user's eye, from the three-dimensional sensor 2 to each of the measurement points in the three-dimensional measurement data obtained by the three-dimensional sensor 2. The operation detecting unit 19 identifies the measurement point which is closest to the eye-gaze detection device 7 among the measurement points having the distances less than a predetermined threshold, determining that the position of the identified measurement point is the position of the user's eye in the real space.

The operation detecting unit 19 can identify the user's actual gaze point by correcting the gaze point represented by a relative position in relation to the eye direction used as a reference with the position of the user's eye in the real space. The operation detecting unit 19 can further identify the user's gaze point on a book in the book region through mapping between the user's gaze point and the book region. The operation detecting unit 19 may thereafter identify the user operation on the basis of the user's gaze point on a book, as with the foregoing embodiments or variation examples. The operation detecting unit 19 may identify an operation in accordance with the gaze point when the user is gazing at the same position for a certain period (e.g., for several seconds). In addition, the operation detecting unit 19 may record history of the points of gaze, and identify an operation in accordance with the moving direction of the gaze point when the point has moved along a predetermined direction.

According to the present variation example, the book detection apparatus can identify the user operation and project the related information in accordance with the identified operation, irrespective of whether the user touches the book or not.

According to another variation example, the related information obtaining unit 18 need not recognize the content appearing on an opened page. Instead, the related information obtaining unit 18 may switch an image to be projected by the projector 6, the image being determined in accordance with the position of the touch by the user or the user's gaze point, as detected by the operation detecting unit 19. In this case, the related information obtaining unit 18 may identify which image to be projected, by referencing a look-up table indicating a relationship between positions where the user touches or the user's points of gaze and images. Such a look-up table may be stored in the storage unit 4 in advance.

Additionally, the operation detecting unit 19 may determine whether the position of the touch by the user or the user's gaze point is included in the book region. For example, concerning a candidate region other than book regions, the operation detecting unit 19 may determine whether a user's finger has touched any surface included in the candidate region by performing a processing similar to the determination as to touches by the user as described above. When a user's finger has touched any surface included in the candidate region, the operation detecting unit 19 may determine that the position of the touch by the user is not included in any book region. Then, the related information obtaining unit 18 may switch an image to be projected by the projector 6, depending on whether the position of the touch by the user or the user's gaze point is included in a book region.

According to still another variation example, either or both of the orientation correcting unit 14 and the deletion determining unit 15 may be omitted. Although detection of a book region may be somewhat less accurate, omitting either or both of the two reduces the amount of calculation needed for the book detection process. When the book detection apparatus is intended to cause the projector 6 to project the information related to the recognized content irrespective of user operations, the operation detecting unit 19 may be omitted.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A book detection apparatus comprising:
a processor configured to:
detect a plurality of surface regions based on three-dimensional measurement data that is obtained by a three-dimensional sensor and that falls within a search area; and
determine, when a positional relationship between two surface regions among the plurality of surface regions satisfies a positional condition corresponding to a positional relationship between two opened pages of an opened book, the two surface regions as a book region that includes the book.

2. The book detection apparatus according to claim 1, wherein the processor is further configured to determine a longitudinal direction and a transverse direction of each of the plurality of surface regions,
and wherein determination of the book region includes determining that the positional condition is satisfied when a distance between the two surface regions is equal to or less than a distance threshold and a difference between lengths in the longitudinal direction of the two surface regions or a difference between lengths in the transverse direction of the two surface regions is equal to or less than a length threshold.

3. The book detection apparatus according to claim 1, wherein the processor is further configured to calculate a position of the centroid of each of the plurality of surface regions; and
select, with respect to a first surface region among the plurality of surface regions, a second surface region and a third surface region whose centroids are in order from the closest to the centroid of the first surface region,
wherein determination of the book region includes determining the first surface region and the second surface region as the book region when a positional relationship between the first surface region and the second surface region satisfies the positional condition and a positional relationship between the first surface region and the third region does not satisfy the positional condition.

4. The book detection apparatus according to claim 1, wherein the processor is further configured to determine, for each of the plurality of surface regions, whether the surface region is flat or curved, based on a variance of normal directions to a plurality of individual measurement points that are included in the surface region and that are included in the three-dimensional measurement data, or on a maximum value of a positional difference between two measurement points among the plurality of measurement points along a normal direction to the whole surface region.

5. The book detection apparatus according to claim 4, wherein determination as to whether the surface is flat is curved includes determining that the surface region is flat when the variance of normal directions is equal to or less than a variance threshold, while the surface region is curved when the variance is greater than the variance threshold.

6. The book detection apparatus according to claim 4, wherein the processor is further configured to
calculate, for the surface region determined to be curved, a degree of positional change along a normal direction to the surface region with respect to a direction in the surface region corresponding to a direction along which pages of the book are bound, and,
delete, when the degree of change is greater than a variable threshold, the surface region.

7. The book detection apparatus according to claim 1, wherein the processor is further configured to detect a range corresponding to the book region on an image of the search area taken by a camera.

8. The book detection apparatus according to claim 7, wherein detection of the range corresponding to the book region includes dividing, when any of the surface regions included in the book region is curved, the surface region into a plurality of blocks along the direction of curvature of the surface region and correcting the range by projective transformation where each of the plurality of blocks is projected onto a flat surface.

9. The book detection apparatus according to claim 7, further comprising a related information obtaining device configured to detect content appearing on any of the two opened pages of the book based on the range corresponding to the book region on the image and obtain information related to the content, wherein the processor is further configured to cause a projector to project the related information.

10. The book detection apparatus according to claim 9, wherein projection of the related information includes determining an image display region that corresponds to the book region and that is present on a display surface of the projector, and displaying the related information in the image display region on the display surface of the projector.

11. The book detection apparatus according to claim 10, wherein the processor is further configured to detect time-dependent change in a position or orientation of the book region and identify an operation in accordance with the identified time-dependent change in the position or orientation, wherein
projection of the related information includes changing information to be projected by the projector in accordance with the identified operation.

12. The book detection apparatus according to claim 10, wherein the processor is further configured to detect a position where a user has touched the book based on the three-dimensional data and identify an operation in accordance with the detected position, wherein
projection of the related information includes changing information to be projected by the projector in accordance with the identified operation.

13. The book detection apparatus according to claim 10, wherein the processor is further configured to detect, based on an image of a user's eye, the image being obtained by an eye-gaze detection device that includes a camera for taking an image of the user's eye, a gaze point of the user on the book, and identify an operation according to the gaze point, wherein
projection of the related information includes changing information to be projected by the projector in accordance with the identified operation.

14. A method for detecting a book comprising:
detecting a plurality of surface regions based on three-dimensional measurement data that is obtained by a three-dimensional sensor and that falls within a search area; and
determining, when a positional relationship between two surface regions among the plurality of surface regions satisfies a positional condition corresponding to a positional relationship between two opened pages of an opened book, the two surface regions as a book region that includes the book.

15. The book detection method according to claim 14, further comprising determining a longitudinal direction and a transverse direction of each of the plurality of surface regions,
and wherein determination of the book region includes determining that the positional condition is satisfied when a distance between the two surface regions is equal to or less than a distance threshold and a difference between lengths in the longitudinal direction of the two surface regions or a difference between lengths in the transverse direction of the two surface regions is equal to or less than a length threshold.

16. The book detection method according to claim 14, further comprising:
calculating a position of the centroid of each of the plurality of surface regions; and
selecting, with respect to a first surface region among the plurality of surface regions, a second surface region and a third surface region whose centroids are in order from the closest to the centroid of the first surface region,
wherein determination of the book region includes determining the first surface region and the second surface region as the book region when a positional relationship between the first surface region and the second surface region satisfies the positional condition and a positional relationship between the first surface region and the third region does not satisfy the positional condition.

17. The book detection method according to claim 14, further comprising detecting a range corresponding to the book region on an image of the search area taken by a camera.

18. The book detection method according to claim 17, further comprising:
detecting, by a related information obtaining device, content appearing on any of the two opened pages of the book based on the range corresponding to the book region on the image and obtaining information related to the content; and
causing a projector to project the related information.

19. A non-transitory computer-readable recording medium having recorded thereon a computer program for book detection that causes a computer to execute a process comprising:
detecting a plurality of surface regions based on three-dimensional measurement data that is obtained by a three-dimensional sensor and that falls within a search area; and
determining, when a positional relationship between two surface regions among the plurality of surface regions satisfies a positional condition corresponding to a positional relationship between two opened pages of an opened book, the two surface regions as a book region that includes the book.
